(19) United States
(12) Patent Application Publication
(10) Pub. No.: US 2010/0161085 A1
(43) Pub. Date: Jun. 24, 2010

(54) PERIPHERAL DEVICE OF PROGRAMMABLE CONTROLLER, METHOD OF VARIABLE SUBSTITUTION, AND COMPUTER PROGRAM PRODUCT THEREOF

(75) Inventor: Masanobu Sumiya, Nagoya-shi (JP)

Correspondence Address: SUGHRUE MION, PLLC, 2100 PENNSYLVANIA AVENUE, N.W., SUITE 800, WASHINGTON, DC, 20037, US

(73) Assignee: Mitsubishi Electric Corporation, Chiyoda-ku Tokyo (JP)

(21) Appl. No.: 12/089,858

(22) PCT Filed: Feb. 19, 2007
(86) PCT No.: PCT/JP2007/052982

§ 371 Date: Apr. 10, 2008

(51) Int. Cl. G05B 19/05

(52) U.S. Cl. 700/86

(57) ABSTRACT

A peripheral device of a programmable controller for converting an existing program into a program with variables substituted therein. The peripheral device includes a variable-information creating unit and a substituting unit. The variable-information creating unit extracts an address from the existing program, assigns a unique variable to the address, and creates variable-correspondence information on correspondence between the address and the variable. The substituting unit substitutes the variable for the address to convert the existing program into the program with variables substituted therein.

### TECHNICAL FIELD

The present invention generally relates to a peripheral device of a programmable controller, a method of variable substitution, and a computer program product thereof. The present invention particularly relates to a peripheral device of a programmable controller, a method of variable substitution, and a computer program product thereof that simplify creating and editing of a sequence program of a programmable logic controller (hereinafter, sometimes referred to as PLC).

### BACKGROUND ART

Internal-memory addresses of a PLC have been defined in the codes of a sequence program that is created or edited in a peripheral device of the PLC.

However, recently, a sequence program is created by using variables instead of internal-memory addresses of a PLC. That is, instead of directly defining internal-memory addresses of the PLC, a sequence program is created by defining variables that substitute for the internal-memory addresses. A sequence program created by such a method includes a code in which, e.g., “LD (variable)” is defined instead of an internal-memory address “LD X0”.

Patent Document 1: Japanese Patent Application Laid-Open No. 2000-242313

### DISCLOSURE OF INVENTION

### Problem to be Solved by the Invention

Generally, to simplify creation of a new sequence program, an existing sequence program created in past is reused.

A sequence program needs to be compiled before using it in a PLC. When a new sequence program is created by reusing an existing sequence program, it is necessary to substitute old addresses in the existing sequence program by new addresses in the PLC while compiling.

When a project, which includes a sequence program with variables such as above substituted therein, is created by reusing an existing sequence program without variables, it is first necessary to copy the existing sequence program and then substitute variables for devices in the copied sequence program by declaring input-output addresses (input-output devices) as global variables and internal-memory addresses (internal devices) as local variables.

A global variable can be used in all programs in a specific project and is independent of any single program in the project. Thus, by declaring a global variable, it is possible to share its value in all programs in the project. On the other hand, a local variable can be used only in a program in which it is defined. That is, each local variable belongs to the program in which it is defined. Thus, a local variable is used when it is not necessary to share its value with other programs in the project. Thus, by using global variables and local variables, a program can be efficiently edited even by a plurality of people.

Conventionally, a programmer has to manually substitute variables for addresses while making sure that there is no duplication of addresses. That makes the substitution a complicated and time consuming task. Moreover, it is difficult to efficiently reuse an existing sequence program without variables.

A conventional technology is disclosed to automatically substitute global variables and local variables for memory addresses (refer to Patent document 1). However, such a conventional technology does not take into account reusing an existing sequence program without variables.

The present invention has been achieved to solve the above problems in the conventional technology and it is an object of the present invention to provide a peripheral device of a programmable controller, a method of variable substitution, and a computer program product thereof that enable to automatically and efficiently convert an existing sequence program without variables into a sequence program with variables substituted therein.

### Means for Solving Problem

To solve the problems and achieve the object mentioned above, according to an aspect of the present invention, there is provided a peripheral device of a programmable controller for converting an existing program into a program with variables substituted therein. The peripheral device of a programmable controller includes a variable-information creating unit that extracts an address from the existing program, assigns a unique variable to the address, and creates variable correspondence information on correspondence between the address and the variable; and a substituting unit that substitutes the address with the variable based on the variable-correspondence information to convert the existing program into the program with variables substituted therein.

### Effect of the Invention

As just described, with the peripheral device of a programmable controller of the present invention, an address is extracted from an existing program, and a unique variable is assigned to the address. The address is associated with the variable to thereby automatically create variable-correspondence information on correspondence between the address and the variable. Based on the variable-correspondence information, the address is automatically substituted with the variable such that the existing program can be converted into a program with variables substituted therein. Thus, it is possible to automatically and efficiently convert an existing sequence program into a sequence programs with variables substituted therein.

### BRIEF DESCRIPTION OF DRAWINGS

FIG. 1 is an example configuration of a program creating system according to an embodiment of the present invention.

FIG. 2 is an example of an existing sequence program in existing project data.

FIG. 3 is an example of a device comment in the existing project data.

FIG. 4 is a functional block diagram of a program creating device of a program creating device according to the embodiment of the present invention.

FIG. 5 is an example of an address classification table in the program creating device according to the embodiment of the present invention.

FIG. 6 is an example of a variable table in the program creating device according to the embodiment of the present invention.

FIG. 7 is an example of a global-variable table in the program creating device according to the embodiment of the present invention.

FIG. 8 is an example of a local-variable table in the program creating device according to the embodiment of the present invention.

FIG. 9 is an example of a sequence program with variables substituted therein that is converted from the existing sequence program.

FIG. 10 is a block diagram of a storage unit of the program creating device according to the embodiment of the present invention.

FIG. 11 is a flowchart of a process of creating a variable table in the program creating device according to the embodiment of the present invention.

FIG. 12 is a diagram for explaining the creation of the variable table in the program creating device according to the embodiment of the present invention.

FIG. 13 is a flowchart of a process of variable substitution in the program creating device according to the embodiment of the present invention.

FIG. 14 is a diagram for explaining variable substitution in a sequence program in the program creating device according to the embodiment of the present invention.

FIG. 15 is a flowchart for explaining declaration of global variables in the program creating device according to the embodiment of the present invention.

FIG. 16 is a diagram for explaining creation of a global-variable table in the program creating device according to the embodiment of the present invention.

FIG. 17 is a flowchart for explaining declaration of local variables in the program creating device according to the embodiment of the present invention.

FIG. 18 is a diagram for explaining creation of a local-variable table in the program creating device according to the embodiment of the present invention.

FIG. 19 is a diagram for explaining functionality of the program creating device according to the embodiment of the present invention.

FIG. 20 is a diagram for explaining functionality of the program creating device according to the embodiment of the present invention.

FIG. 21 is a block diagram of an example of a computer that executes a program to implement variable substitution method for creating a program according to the embodiment of the present invention.

### EXPLANATIONS OF LETTERS OR NUMERALS

1 Program creating device
3 Input device
5 Display device
7 External storage device
11 Program creating unit
13 Storage unit
15 Communication unit
17 Controlling unit
71 Existing project data
72 Existing sequence program
73 Device comment
111 Variable-table creating unit
112 Global-variable-table creating unit
113 Local-variable-table creating unit
114 Substituting unit
115 Program creator
131 Program memory
132 Data memory
133 New project memory
134 Global-variable table
135A Sequence program A
135B Sequence program B
136A Local-variable table A
136B Local-variable table B
137 Address classification table
138 Variable table
139 New project data
201 Input device
202 Display device
203 CPU
204 Memory
205 Storage device
206 Storage-medium drive
207 Network interface
208 Bus

### BEST MODE(S) FOR CARRYING OUT THE INVENTION

Exemplary embodiments of a peripheral device of a programmable logic controller (PLC), a method of variable substitution, and a computer program product thereof according to the present invention are described in detail below with reference to the accompanying drawings. The present invention is not limited to the embodiments described below and can be modified in various manners without departing from its scope.

### Embodiment

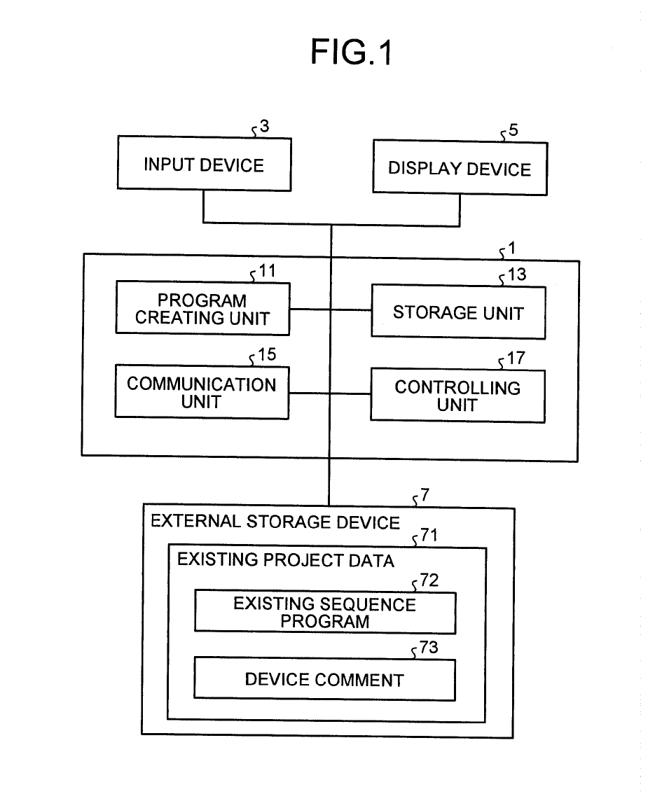

FIG. 1 is an example configuration of a program creating system, which has features of a peripheral device of a PLC, according to an embodiment of the present invention. As shown in FIG. 1, the program creating system includes a program creating device 1, which functions as a peripheral device of the PLC, an input device 3, a display device 5, and an external storage device 7.

In a conventional program creating device, to create a new project of a sequence program with variables substituted therein by reusing an existing sequence program without variables, the existing sequence program is first copied to the new project. The input-output addresses (input-output devices) in the copied sequence program are then declared as global variables, while internal-memory addresses (internal devices) are declared as local variables such that the devices in the copied sequence program are substituted by variables.

With a conventional technology, a programmer has to manually substitute variables for addresses while making sure that there is no duplication. That makes the programmer overburdened with the substitution task. Moreover, it is difficult to efficiently reuse an existing sequence program without variables.

Unlike the conventional technology, it is possible to automatically perform the substitution task by using the program creating device 1 of the embodiment. Thus, without troubling the programmer for manual substitution of variables, a new project of a sequence program can be efficiently created by reusing an existing sequence program without variables. As shown in FIG. 1, the program creating device 1 includes a program creating unit 11, a storage unit 13, a communication unit 15, and a controlling unit 17.

The input device 3 is used for inputting operational instructions regarding the program creating device 1. The display device 5 displays information such as the sequence program or processing data in the program creating device 1.

The external storage device 7 stores therein existing project data 71 created in past. The existing project data 71 stored in the external storage device 7 includes an existing sequence program 72 without variables and a device comment 73 adjunctive to the existing sequence program 72. The device comment 73 includes an explanatory comment regarding each address (device) defined in the existing sequence program 72.

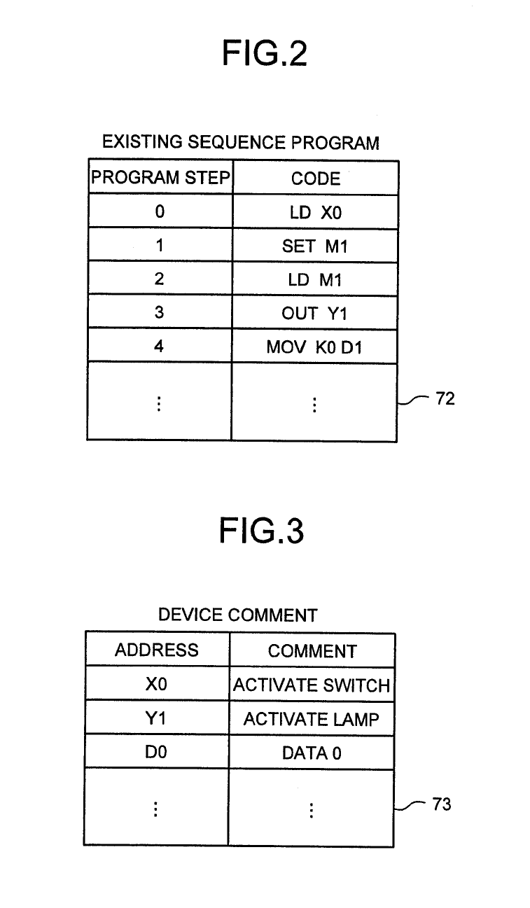

FIG. 2 is an example of the existing sequence program 72 in the existing project data 71. The existing sequence program 72 is reused to create a new sequence program, as described below. As shown in FIG. 2, a plurality of program steps and a code of each program step are defined in the existing sequence program 72. For example, a code “LD X0” is defined in a program step “step 0”, while a code “SET M1” is defined in a program step “step 1”. That is, the existing sequence program 72 is a program in which actual addresses are defined instead of substituting variables for them.

FIG. 3 is an example of the device comment 73 in the existing project data 71. The device comment 73 is used when a new sequence program is created by reusing the existing sequence program 72, as described below. As shown in FIG. 3, the device comment 73 includes a plurality of addresses defined in the existing sequence program 72 and a comment regarding each address. For example, a comment “activate switch” is defined to explain contents of an address “address X0”, while a comment “activate lamp” is defined to explain contents of an address “address Y1”.

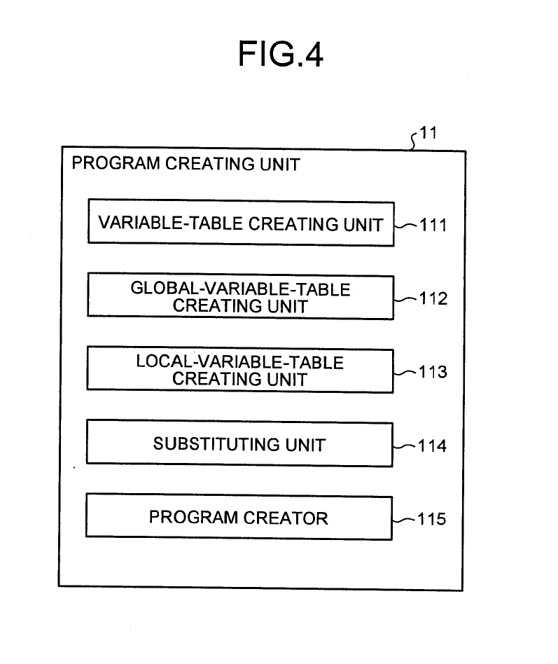

FIG. 4 is a functional block diagram of the program creating unit 11. As shown in FIG. 4, the program creating unit 11 includes a variable-table creating unit 111, a global-variable-table creating unit 112, a local-variable-table creating unit 113, a substituting unit 114, and a program creator 115.

To create a new project of a sequence program with variables substituted therein by reusing an existing sequence program without variables, the variable-table creating unit 111 in the program creating unit 11 copies the existing sequence program 72 and the device comment 73 from the external storage device 7 and stores them in the storage unit 13.

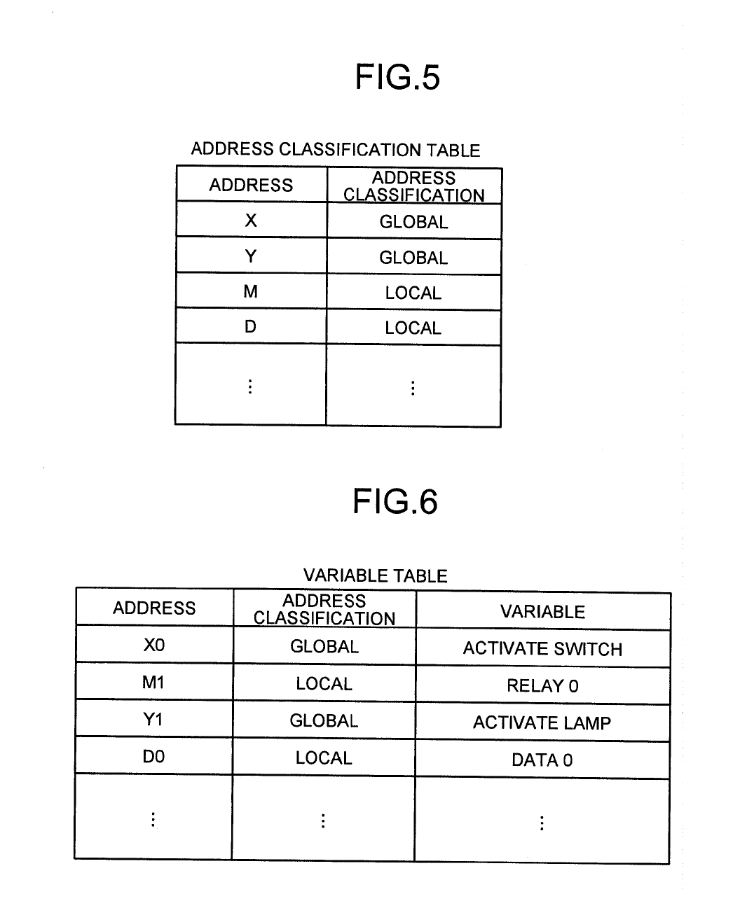

The variable-table creating unit 111 then classifies addresses present in the codes of the copied existing sequence program 72 by searching an address classification table (address classification information), as shown in FIG. 5, which is stored in advance in the storage unit 13. FIG. 5 is an example of an address classification table. Each address is classified into a global address or a local address. Addresses used in a sequence program are stored in the address classification table along with their corresponding classification (global or local).

The variable-table creating unit 111 then creates a variable table (variable information), as shown in FIG. 6, based on the addresses present in the codes of the existing sequence program 72, the classification of the addresses (global or local), and the device comment 73, and stores the variable table into the storage unit 13. FIG. 6 is an example of a variable table. As shown in FIG. 6, a comment, which is included in the device comment 73, regarding each address is used as a variable in the variable table.

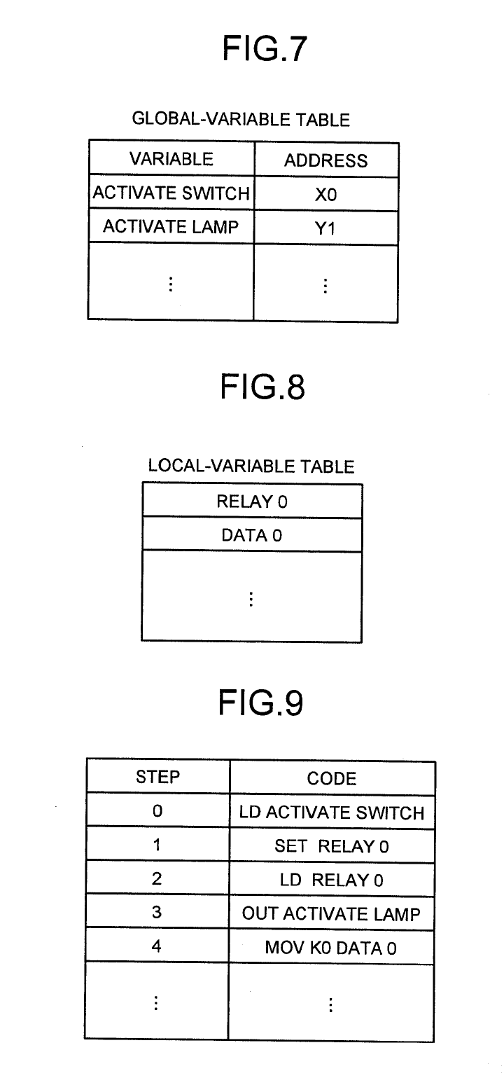

The global-variable-table creating unit 112 extracts the variables having the classification as global and the corresponding addresses from the variable table shown in FIG. 6. The global-variable-table creating unit 112 then declares global variables by storing the extracted variables and the corresponding addresses into a global-variable table (information on global variables) as shown in FIG. 7. FIG. 7 is an example of a global-variable table.

As shown in FIG. 7, the global-variable table stores therein the addresses having the classification as global and the corresponding variables. The global-variable table is used while compiling a new sequence program, which is created by substituting variables for addresses (devices) in an existing sequence program, or a newer sequence program, which is created by using the new sequence program.

The local-variable-table creating unit 113 extracts the variables having the classification as local and the corresponding addresses from the variable table shown in FIG. 6. The local-variable-table creating unit 113 then declares local variables by storing the extracted variables and the corresponding addresses into a local-variable table (information on local variables) as shown in FIG. 8. FIG. 8 is an example of a local-variable table. As shown in FIG. 8, the local-variable table stores therein the addresses having the classification as local and the corresponding variables. The local-variable table is used while compiling a new sequence program, which is created by substituting variables for addresses (devices) in an existing sequence program, or a newer sequence program, which is created by using the new sequence program.

The substituting unit 114 substitutes a variable for each address present in the code of the existing sequence program 72 based on the variable table, which is shown in FIG. 6 and created in the variable-table creating unit 111. Thus, the substituting unit 114 converts the existing sequence program 72 into a sequence program with variables substituted therein. FIG. 9 is an example of a sequence program with variables substituted therein that is converted from the existing sequence program 72 shown in FIG. 2.

When substituting a variable for each address present in the code of the existing sequence program 72, the substituting unit 114 uses a comment, which is included in the device comment 73 shown in FIG. 3, regarding each address as a variable. When there is no comment regarding an address in the device comment 73, the substituting unit 114 uses fixed characters assigned in advanced or assigned on a case-by-case basis as the variable to be substituted for the address without a comment.

The program creator 115 uses the sequence program with variables substituted therein to create a new sequence program.

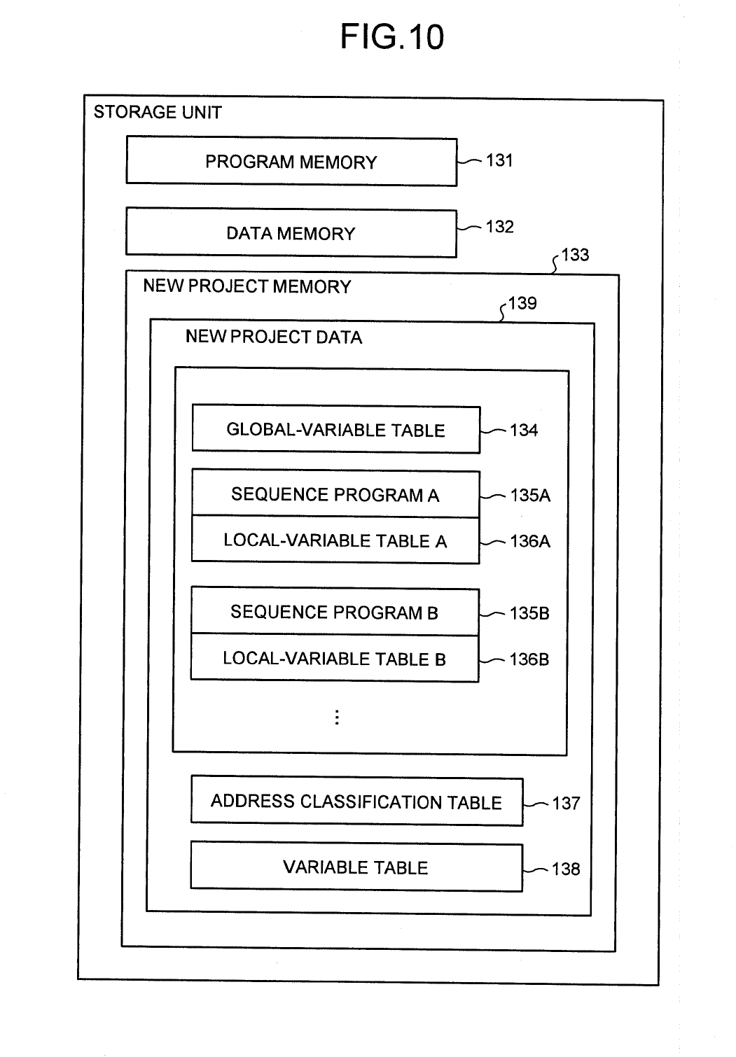

The storage unit 13 stores therein various types of programs necessary for processing in the program creating device 1, or sequence programs and data generated during the processing. FIG. 10 is a block diagram of the storage unit 13. As shown in FIG. 10, the storage unit 13 includes a program memory 131 that stores therein various types of programs necessary for processing in the program creating device 1, a data memory 132 that stores therein data generated during the processing in the program creating device 1, and a new project memory 133 that stores therein a project of sequence programs newly created or edited in the program creating device 1 by reusing existing sequence programs.

The new project memory 133 stores therein a new project data 139 in which, e.g., a global-variable table 134, a sequence program A 135A that is newly created or edited by reusing the existing sequence program 72, a local-variable table A 136A corresponding to the sequence program A 135A, a sequence program B 135B that is newly created or edited by reusing the existing sequence program 72, a local-variable table B 136B corresponding to the sequence program B 135B, an address classification table 137, and a variable table 138 are stored. The storage unit 13 copies the existing sequence program 72 and the device comment 73 from the external storage device 7, and stores them in the data memory 132.

The communication unit 15 functions as an information input-output unit to communicate information between the program creating device 1 and the external storage device 7, which is externally connected to the program creating device 1. The controlling unit 17 controls the program creating device 1 in entirety.

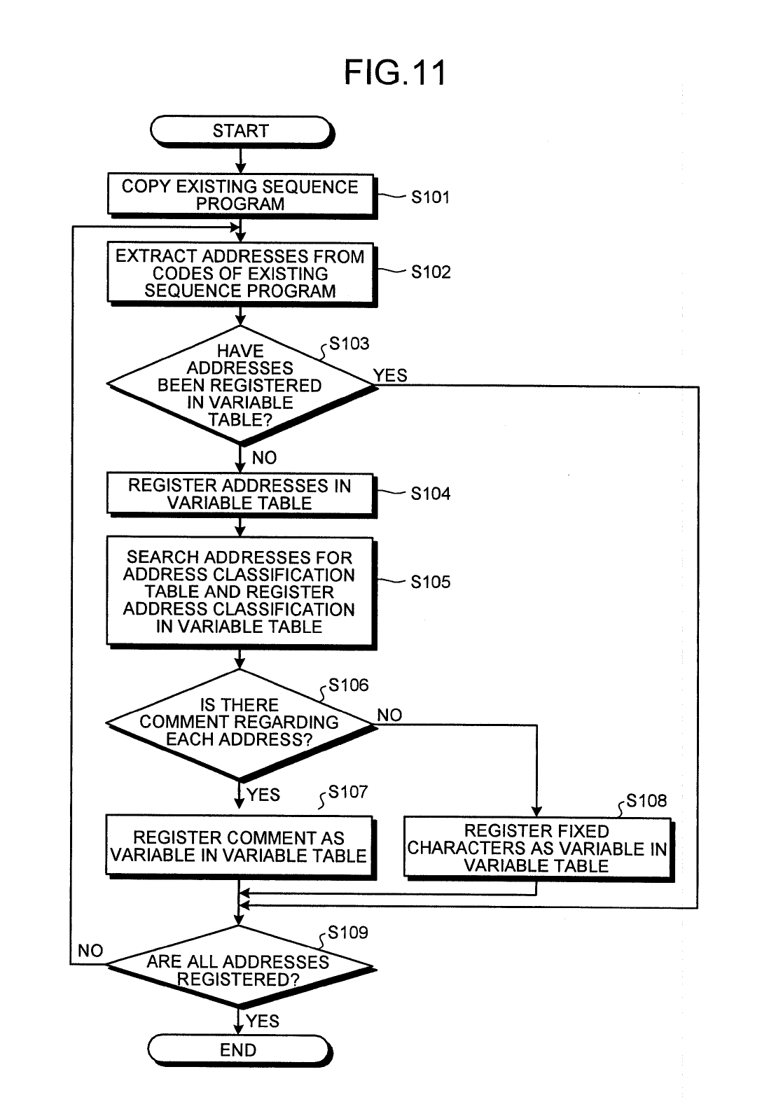

Given below is the description of a process of creating a new sequence program by reusing an existing sequence program created in past by implementing the program creating system of the embodiment. First, a process of creating a variable table is described with reference to FIG. 11. FIG. 11 is a flowchart of the process of creating a variable table in the program creating device 1 according to the embodiment.

To create a variable table, the variable-table creating unit 111 first copies the existing sequence program 72 and the device comment 73 from the external storage device 7, and stores them in the data memory 132 of the storage unit 13 (step S101). The variable-table creating unit 111 then starts searching for addresses (devices) from the beginning of the codes of the existing sequence program 72 and extracts the addresses (devices) (step S102).

The variable-table creating unit 111 refers to a variable table to determine if the extracted addresses (devices) have already been registered in the variable table (step S103). If the extracted addresses (devices) are yet to be registered in the variable table (NO at step S103), the variable-table creating unit 111 registers the extracted addresses (devices) in the variable table (step S104). The variable-table creating unit 111 classifies the addresses (devices) (global or local) by searching the address classification table 137 stored in advance in the storage unit 13 for the addresses, and registers the classification of the addresses (global or local) in the variable table (step S105).

The variable-table creating unit 111 then searches the copied device comment 73 to determine whether there is a comment regarding each address (step S106). If there is a comment regarding an address (YES at step S106), the variable-table creating unit 111 registers the comment as the variable of the corresponding address in the variable table (step S107). On the other hand, if there is no comment regarding an address (NO at step S106), the variable-table creating unit 111 registers fixed characters assigned in advanced or assigned on a case-by-case basis as the variable of the corresponding address in the variable table (step S108).

After registering the variables, the variable-table creating unit 111 determines whether all the addresses (devices) in the codes of the existing sequence program 72 are extracted and registered in the variable table (step S109). If all the addresses (devices) in the codes of the existing sequence program 72 are not yet registered in the variable table (NO at step S109), the process returns to step 5102 for extraction of remaining addresses in the codes of the existing sequence program 72. If all the addresses (devices) in the codes of the existing sequence program 72 are registered in the variable table (YES at step S109), the process of creating the variable table is complete.

Meanwhile, at step 5103, if the extracted addresses (devices) are determined to be registered in the variable table (NO at step S103), the process jumps to step S109. The variable-table creating unit 111 then determines whether all the addresses (devices) in the codes of the existing sequence program 72 are extracted and registered in the variable table (step S109).

If all the addresses (devices) in the codes of the existing sequence program 72 are not yet registered in the variable table (NO at step S109), the process returns to step S102 for extraction of remaining addresses in the codes of the existing sequence program 72. If all the addresses (devices) in the codes of the existing sequence program 72 are registered in the variable table (YES at step S109), the process of creating the variable table is complete.

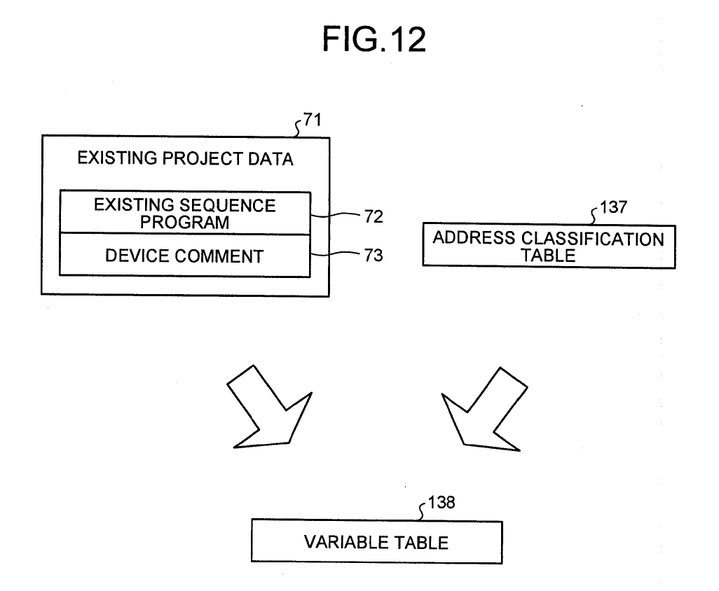

By performing the abovementioned process, the variable table 138 can be created in the program creating device 1 of the embodiment based on the existing sequence program 72 and the device comment 73 in the existing project data 71, as shown in FIG. 12. FIG. 12 is a diagram for explaining the creation of the variable table 138 in the program creating device 1.

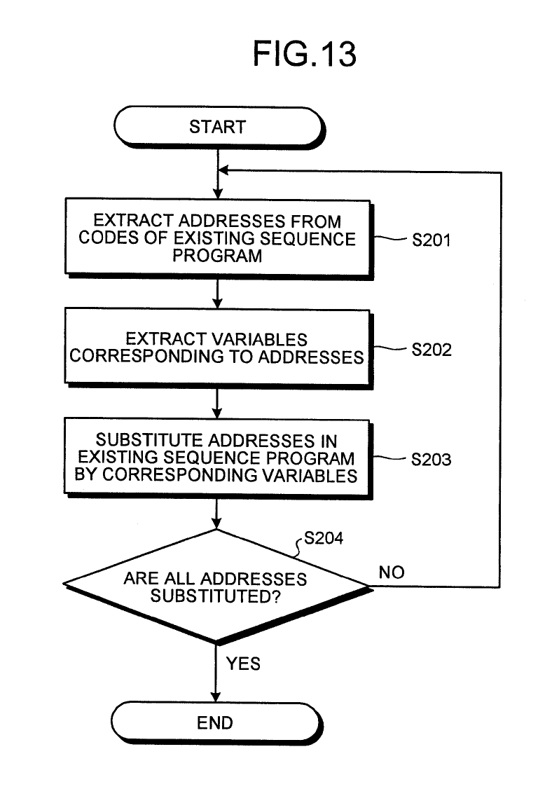

Given below is the description with reference to FIG. 13 of a process of substituting the addresses in the codes of the existing sequence program 72 based on the variable table 138, which is created as described above. FIG. 13 is a flowchart of the process of variable substitution in the program creating device 1 according to the embodiment.

To perform variable substitution in the program creating device 1, the substituting unit 114 in the program creating unit 11 starts searching for addresses (devices) from the beginning of the codes of the existing sequence program 72, which is copied in the storage unit 13, and extracts the addresses (devices) (step S201). The substituting unit 114 then searches for variables corresponding to the extracted addresses and extracts those variables (step S202).

The substituting unit 114 substitutes the addresses in the existing sequence program 72 by the corresponding variables and stores the sequence program after substitution in the new project memory 133 as the sequence program A 135A (step S203). After the substitution is complete, the substituting unit 114 determines whether all the addresses (devices) in the existing sequence program 72 are substituted by the corresponding variables (step S204).

If all the addresses (devices) in the existing sequence program 72 are not yet substituted by the corresponding variables (NO at step S204), the process returns to step S201. On the other hand, if all the addresses (devices) in the existing sequence program 72 are substituted by the corresponding variables (YES at step S204), the process of variable substitution is complete.

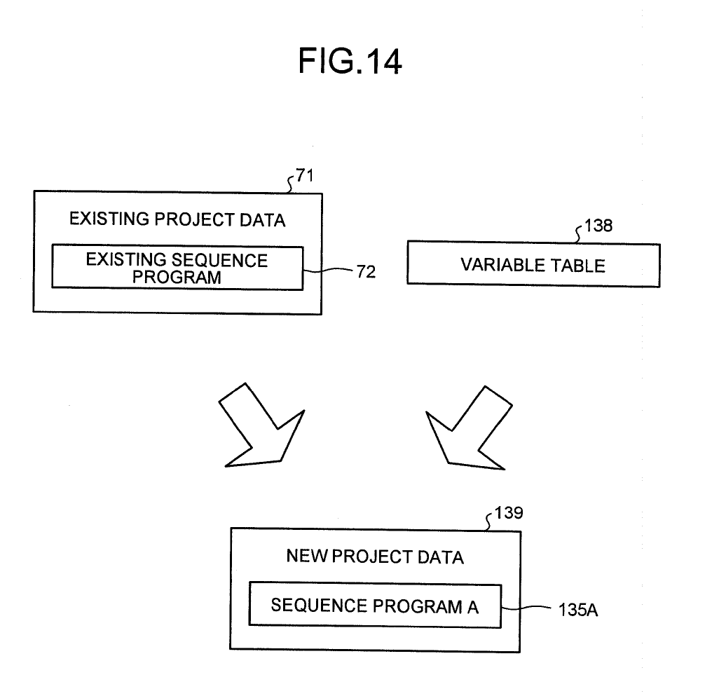

With this, according to the embodiment, based on the existing sequence program 72 in the existing project data 71 and the variable table 138, the addresses (devices) in the existing sequence program 72 can be automatically substituted by variables in the program creating device 1 as shown in FIG. 14. Thus, the existing project data 71 can be converted into a sequence program with variables substituted therein. That is, an existing sequence program without variables can be automatically converted into a new sequence program with variables substituted therein. FIG. 14 is a diagram for explaining variable substitution in the program creating device 1.

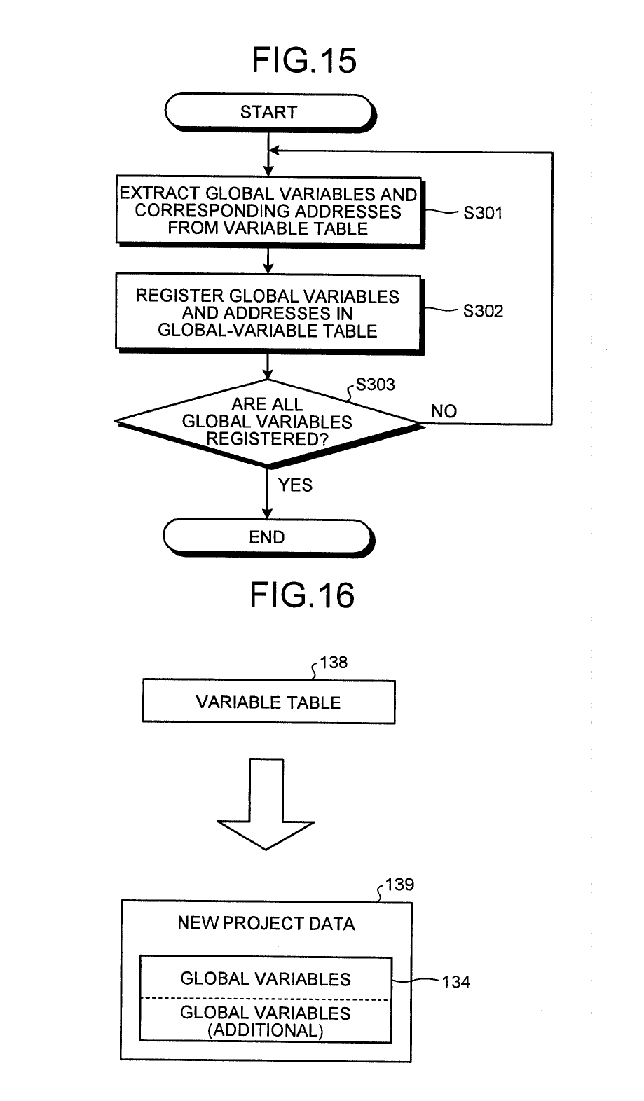

Given below is the description with reference to FIG. 15 of a process of creating a global-variable table and declaring global variables based on the variable table 138, which is created as described above. FIG. 15 is a flowchart for explaining the declaration of global variables in the program creating device 1 according to the embodiment.

To declare global variables in the program creating device 1, the global-variable-table creating unit 112 in the program creating unit 11 extracts from the variable table 138 variables having the classification as global and the corresponding addresses (devices) (step S301). The global-variable-table creating unit 112 then registers the extracted global variables and the corresponding addresses (devices) in the global-variable table 134 (step S302).

After registering the extracted global variables and the corresponding addresses (devices), the global-variable-table creating unit 112 determines whether all the global variables and the corresponding addresses (devices) in the variable table 138 are registered in the global-variable table 134 (step S303).

If all the global variables and the corresponding addresses (devices) in the variable table 138 are not yet registered in the global-variable table 134 (NO at step S303), the process returns to step S301. On the other hand, if all the global variables and the corresponding addresses (devices) in the variable table 138 are registered in the global-variable table 134 (YES at step S303), the process of declaring the global variables is complete.

By the abovementioned process, based on the variable table 138, the global-variable table 134 can be automatically created for declaring the global variables, as shown in FIG. 16. Moreover, a new variable can be declared by adding it and a corresponding address (device) in the global-variable table 134. FIG. 16 is a diagram for explaining the creation of the global-variable table 134 in the program creating device 1.

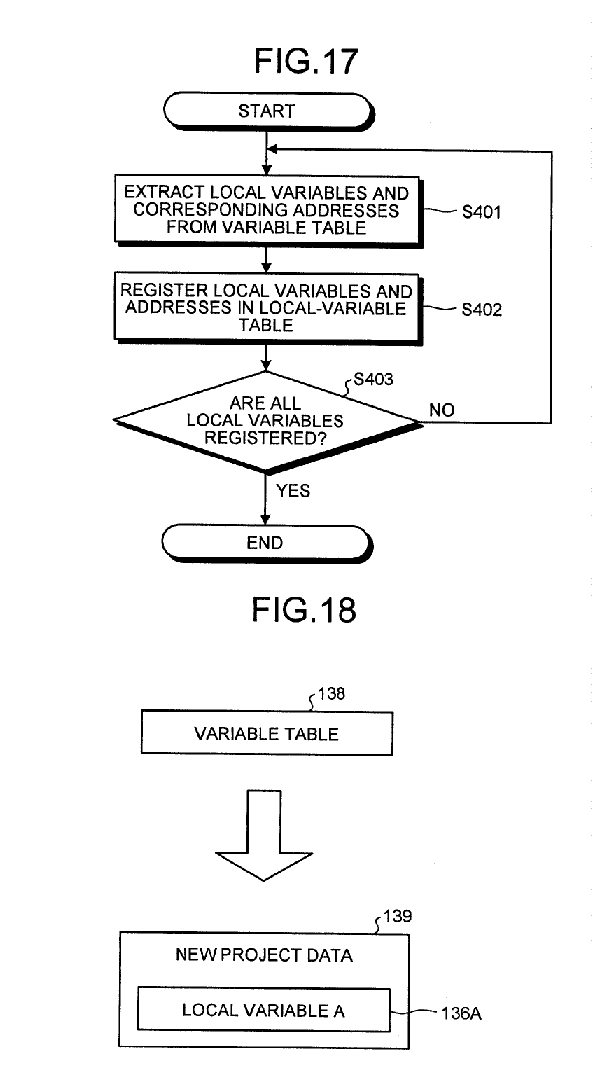

Given below is the description with reference to FIG. 17 of a process of creating a local-variable table and declaring local variables based on the variable table 138, which is created as described above. FIG. 17 is a flowchart for explaining the declaration of local variables in the program creating device 1 according to the embodiment.

To declare local variables in the program creating device 1, the local-variable-table creating unit 113 in the program creating unit 11 extracts from the variable table 138 variables having the classification as local and the corresponding addresses (devices) (step S401). The local-variable-table creating unit 113 then registers the extracted local variables and the corresponding addresses (devices) in the local-variable table A 136A (step S402).

After registering the extracted local variables and the corresponding addresses (devices), the local-variable-table creating unit 113 determines whether all the local variables and the corresponding addresses (devices) in the variable table 138 are registered in the local-variable table A 136A (step S403).

If all the local variables and the corresponding addresses (devices) in the variable table 138 are not yet registered in the local-variable table A 136A (NO at step S403), the process returns to step S401. On the other hand, if all the local variables and the corresponding addresses (devices) in the variable table 138 are registered in the local-variable table A 136A (YES at step S403), the process of declaring the local variables is complete.

By the abovementioned process, based on the variable table 138, the local-variable table A 136A corresponding to the sequence program A 135A can be automatically created for declaring the local variables, as shown in FIG. 18. FIG. 18 is a diagram for explaining the creation of the local-variable table A 136A in the program creating device 1.

The program creator 115 in the program creating device 1 can reuse the sequence program A 135A with variables substituted therein to newly create, e.g., the sequence program B 135B and store it in the new project memory 133. At that time, it is possible to declare a new global variable by adding it and a corresponding address (device) in the global-variable table 134, as described above. Moreover, as described above, it is also possible to create the local-variable table B 136B corresponding to the sequence program B 135B for declaring local variables.

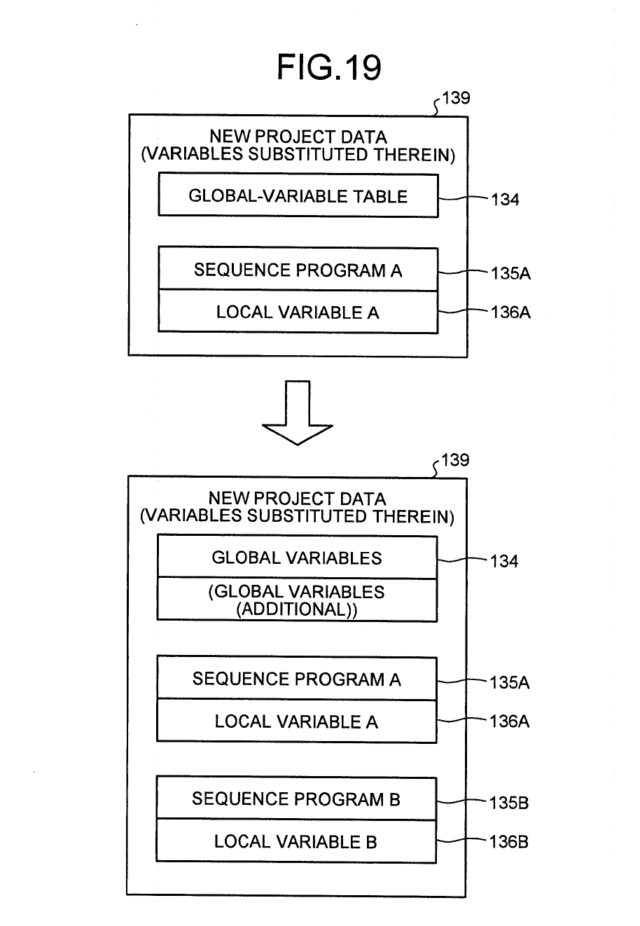

Thus, the sequence program A 135A with variables substituted therein can be reused to newly create the sequence program B 135B, as shown in FIG. 19. FIG. 19 is a diagram for explaining the functionality of the program creating device 1 according to the embodiment.

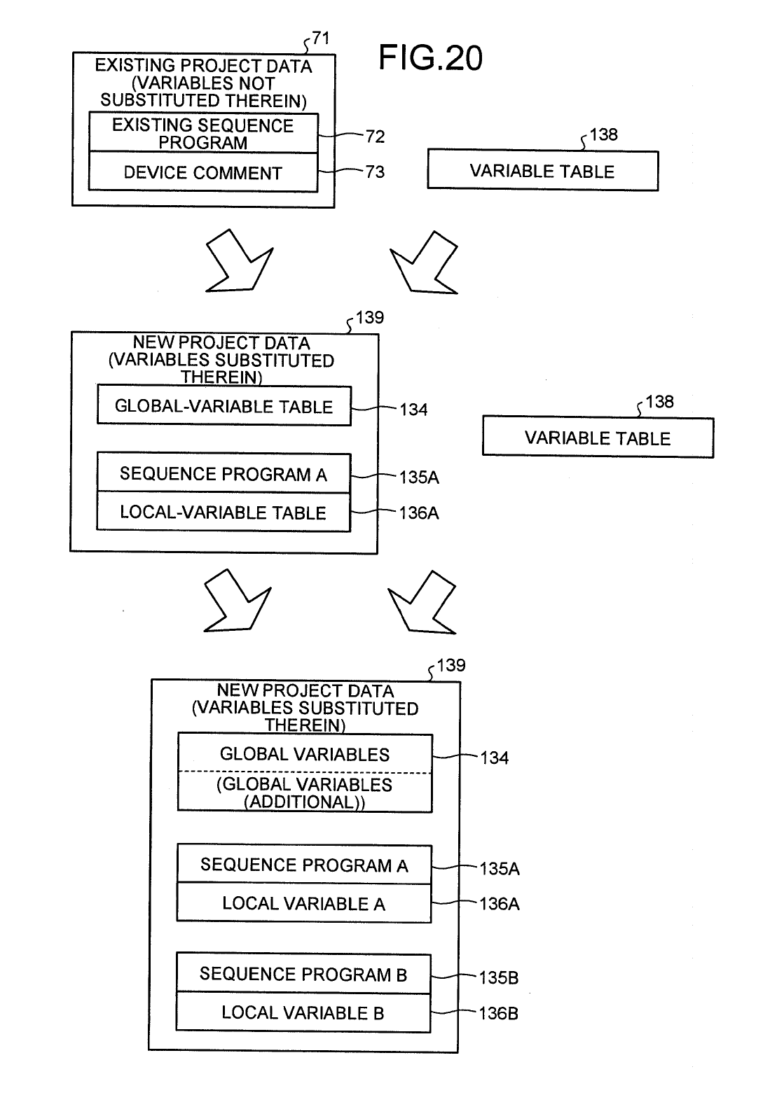

To sum up, as shown in FIG. 20, with the program creating device 1, the sequence program A 135A, the local-variable table A 136A, and the global-variable table 134 in the new project data 139 can be automatically created and modified based on the existing sequence program 72 and the device comment 73 in the existing project data 71, and the variable table 138.

Moreover, the sequence program B 135B, the local-variable table B 136B, and the global-variable table 134 in the new project data 139 can be created and modified based on the sequence program A 135A, the local-variable table A 136A, the global-variable table 134, and the variable table 138 in the new project data 139. FIG. 20 is a diagram for explaining the functionality of the program creating device 1.

As described above, the program creating device 1 is a peripheral device of a PLC for creating and editing a sequence program of the PLC. By using the program creating device 1, it is possible to create a sequence program in which addresses (devices) such as input-out addresses (input-output devices) or internal memory addresses (internal devices) of the PLC are substituted by variables. That is, a sequence program is created by substituting variables for addresses, instead of directly defining the addresses.

Moreover, it is possible to reuse an existing sequence program created in past to create a new sequence program in the program creating device 1. A new sequence program with variables substituted therein can be created by reusing an existing sequence program also with variables substituted therein. Furthermore, a new sequence program with variables substituted therein can also be created by reusing an existing sequence program without variables.

In that case, addresses (devices) in the existing sequence program without variables are automatically substituted by variables in the program creating device 1 to create the new sequence program with variables substituted therein.

Although an input device and a display device are arranged external to a program creating device as described above, it is also possible to configure a program creating device to include the input device and the display device. Moreover, although an external storage device is directly connected to the program creating device as described above, it is also possible to make the connection between the program creating device and the external storage device through a network. Moreover, although the existing project data 71 is stored in the external storage device 7 as described above, it is also possible to store the existing project data 71 in the storage unit 13 included in the program creating device 1.

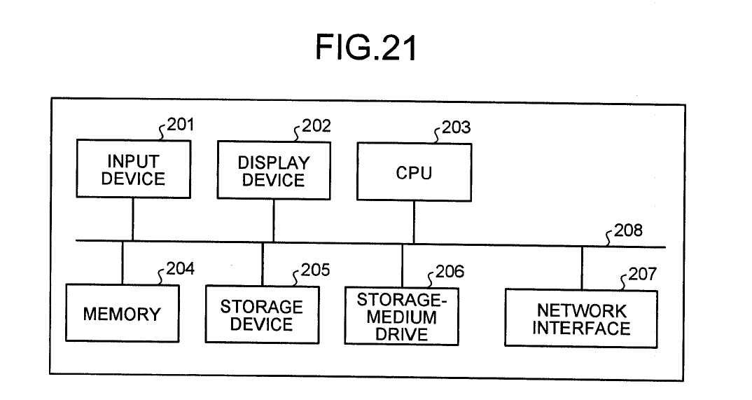

The abovementioned processes of variable substitution and program creation can be programmed and executed on a computer (a peripheral device of a programmable controller) that includes a CPU, and a storage device as shown in FIG. 21.

FIG. 21 is a block diagram of an example of a computer that execute a program to implement the abovementioned variable substitution method for creating a program. The computer includes an input device 201, a display device 202, a CPU (central processing unit) 203, a memory 204, a storage device 205, a storage-medium drive 206, a network interface 207, and a bus 208.

The input device 201 includes a keyboard, a mouse, a touch panel, a scanner, etc., and is used for inputting information. The display device 202 displays output information or the information input from the input device 201. The CPU 203 executes various programs. The memory 204 stores therein temporary information generated when programs are built and executed in the CPU 203. The storage device 205 stores therein programs and the temporary information generated when the programs are executed. The storage-medium drive 206 loads therein a storage medium, reads programs or data from the storage medium, and stores that information in the memory 204 or the storage device 205. The network interface 207 connects the computer to a network. The bus 208 interconnects all the abovementioned units of the computer.

Although the above description is regarding an exemplary case of sequence program creation of a PLC, the present invention is not limited to sequence program creation of only a PLC but can be implemented in a general case of sequence program creation.

### INDUSTRIAL APPLICABILITY

A peripheral device of a programmable controller according to the present invention is suitable for creating a new sequence program by reusing an existing sequence program without variables.

1.-7. (canceled)

8. A peripheral device of a programmable controller for converting a first program into a second program including a code using a variable, the peripheral device comprising:
an extracting unit that extracts an address from the first program;
an assigning unit that assigns a unique variable to the address;
a creating unit that creates correspondence information on correspondence between the address and the variable based on classification of the address; and
a substituting unit that substitutes the address with the variable based on the correspondence information to convert the first program into the second program.

9. The peripheral device of a programmable controller according to claim 8, wherein the classification of the address is any one of a global address and a local address, the peripheral device of a programmable controller further comprising:
a variable-information creating unit that extracts a global address and a corresponding variable from the correspondence information, and creates global-variable information on correspondence between the global address and the corresponding variable.

10. The peripheral device of a programmable controller according to claim 8, wherein the classification of the address is any one of a global address and a local address, the peripheral device of a programmable controller further comprising:
a variable-information creating unit that extracts a local address and a corresponding variable from the correspondence information, and creates local-variable information on correspondence between the local address and the corresponding variable.

11. A method of variable substitution for converting a first program into a second program including a code using a variable, the method comprising:
extracting an address from the first program;
assigning a unique variable to the address;
creating correspondence information on correspondence between the address and the variable based on classification of the address; and
substituting the address with the variable based on the correspondence information to convert the first program into the second program.
